(19) United States
(12) Patent Application Publication
(10) Pub. No.: US 2006/0031357 A1
(43) Pub. Date: Feb. 9, 2006

(54) Method of and system for management of electronic mail

(75) Inventors: Ramesh Misra, Kanata (CA); Stephen Spence, Kanata (CA)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: NorthSeas Advanced Messaging Technology, Inc., Kanata (CA)

(21) Appl. No.: 11/137,854

(22) Filed: May 25, 2005

Related U.S. Application Data
(60) Provisional application No. 60/574,267, filed on May 26, 2004.

(51) Int. Cl. G06F 15/16

(52) U.S. Cl. 709/206; 709/203

(57) ABSTRACT

The present invention relates to electronic communication systems, and more specifically, to a method of and system for management of electronic mail or e-mail. E-mail use has become pervasive in western industry, and it is necessary to provide an efficient system and method for archiving the vast number of e-mail messages that are received in business environments. The invention intercepts messages before they arrive in the corporate e-mail system, using an e-mail gateway. E-mail is stored as a flat-file in a central storage device and tools are provided to allow searching, previewing, replaying or re-delivering, replying, forwarding and re-delivery of those stored messages. The replaying, replying, forwarding and re-delivery tools all employ the User's existing message delivery system.

### CROSS-REFERENCE TO RELATED PATENT APPLICATION

This application claims the benefit, pursuant to 35 U.S.C. §119(e), of provisional U.S. patent application Ser. No. 60/574,267, filed May 25, 2004, entitled “Method and Apparatus for Deploying and Winding Fiber Optic Cable,” which is incorporated herein by reference in its entirety.

### FIELD OF INVENTION

The present invention relates to electronic communication systems, and more specifically, to a method of and system for management of electronic mail or e-mail.

### BACKGROUND OF THE INVENTION

The use of electronic mail or E-mail has grown to its current unwieldy scope largely because of the worldwide acceptance of the standard networking protocol—TCP/IP—that resulted in a global connection of individuals and organizations into one virtual worldwide network, the Internet. The standard for Internet e-mail communication, the Simple Mail Transport Protocol or SMTP, provides pervasive and almost instantaneous communication that transcends distance and time.

In 2005, according to industry analyst firm, Osterman Research, the average business e-mail user sends and receives 25,000 e-mail messages every year, consuming 16 Mbytes of data per day. This usage is expected to continue growing for the foreseeable future at 30% per year.

E-mail archiving, that is, the storage of e-mail documents for future retrieval, serves at least four important business purposes: improved e-mail storage management, compliance with record retention policies and regulations, access for legal discovery, and more accessible corporate knowledge. To elaborate:
1. E-mail Storage Management:

Daily business e-mail communication has now reached a level that even just a few years ago would have seemed unimaginable to most system managers. This excessive messaging load has become such a burden on both users and administrators that it now threatens to strip e-mail—the most effective business communication tool ever invented—of much of its essential value.

The conflict between the need to manage the explosive growth of e-mail combined with the reality that it is now too risky for organizations to regularly delete messages is a paradox that demands a new model for e-mail storage.

Mail-servers offer insufficient storage capacity and leaving messages on the server quickly ends up causing performance problems. However, downloading and storing e-mail messages in individual user's computers usually prohibits central accessibility. For most organizations, neither of these options is acceptable.

As a result, there is a growing need for e-mail storage systems that create a scalable, centralized corporate repository, independent of the mail-server, but easily accessible to users so that server performance implications of the current model of ever-expanding message stores can be avoided.

Sheer volume alone demands more effective e-mail storage. A 2004 study by industry-specialist's Osterman Research found that the average server-based mailbox quota was 100 MB per user (and growing). Considering that the daily use of e-mail in 2005 commonly exceeds 16 Mb per day per person, the average mailbox offers users less than 7 days of storage capacity.

2. Compliance

As a result of shortfalls in corporate record keeping and reporting evident in the collapses of several corporate giants, the Sarbanes-Oxley Act into law in the United States in 2002. The Sarbanes-Oxley Act provides a wide range of enhanced accountability measures for publicly traded corporations and sets a new standard of responsible management for all corporations and government agencies.

According to industry consultant IDC, 60% of critical business information is contained within e-mails and their attachments. As a result of the Sarbanes-Oxley Act and other related regulations from SEC (Security Exchange Commission), NYSE (New York Stock Exchange), and others, e-mail communication must now be managed as official business records, with the same rigor as other corporate records. E-mail messages must be retained for years and be presented when requested. The US Health Insurance Portability and Accountability Act (HIPAA), for example, imposes similar regulatory requirements for records management for healthcare and pharmaceuticals industries. Government agencies and departments, who are subject to costly and time consuming Access to Information and Privacy (ATIP) requests and have a responsibility as caretakers of the public record, are also accountable for management of e-mail as records.

Because the Sarbanes-Oxley Act (SOX) provides few details, there is considerable confusion and debate over exactly what e-mail must be retained and what can be deleted. To avoid the possibility of large fines and prison sentences, the approach being broadly adopted is to protect against any possibility of inadvertent deletion of records by capturing and retaining all e-mail activity.

In summary, SOX provides a guideline to public companies, and those that may someday be governed by public companies, with respect to e-mail record retention:
Companies must have a responsible e-mail retention policy (a regular 90-day deletion schedule for example is not likely to be considered “responsible”);
Companies must have a process in place that supports or governs this policy; and
Companies must adhere to their policy and apply their process, consistently.

3. Legal Discovery

Even organizations not governed by record retention regulations must be careful not to delete e-mail messages too freely. According to Osterman Research, 40% of companies surveyed in 2004 said that they were required at least once to present a specific e-mail by a court or regulatory body—even an old one—or face possible penalties. It is no longer prudent or protective for companies to employ a regular short-term e-mail deletion policy.

Recent legal cases have set a precedent that the defendant must bear the cost of finding messages requested by the court. Therefore, the need to provide quick and easy access to old e-mail messages, in addition to the need to capture and retain them, has become an important factor for all businesses. Locating messages stored on back-up tapes is not a viable option for most organizations.

4. Corporate Knowledge

According to IBM Research, at least 85% of the non-structured information that flows in and out of most businesses is in the form of an e-mail message and/or its attachment. E-mail storage systems that do not establish a central repository of this valuable knowledge hamper the company's ability to leverage this knowledge.

E-mail content that is captured in repositories or back-ups that are not easily accessible by company executives and information managers is similarly of limited value to the organization. The ability to quickly access and retrieve information contained within e-mail messages and attachments dating back years can offer a distinct competitive advantage for that organization.

As a result of the attention now paid to the responsibility of corporations and service providers to manage electronic business records, it will be increasingly likely that organizations will at some point be forced to defend their company's records management (and e-mail retention) process. In these discovery situations, the organization must be able to provide substantive proof that it takes its responsibility as stewards of information assets seriously and has taken every precaution to ensure the integrity and accuracy of its records.

An e-mail archive that is inherently flawed may have serious repercussions for the organization in the future when it is called upon to defend its process. An archival process that ensures the complete integrity of the archival process and the authenticity of its contents can help the organization avoid hardship and possibly harsh penalties when urgent discovery is required.

Attempting to address the need for e-mail archiving through conventional methods—such as backing up servers more regularly and placing usage restrictions on users—will not provide a solution to these challenges. If anything, conventional methods may serve only to exacerbate records management problems by either limiting access to records or by leaving retention decisions up to individual employees.

Existing e-mail archiving software processes automatically copy e-mails messages to a separate network storage facility. In this way, messages can be automatically deleted from servers, while providing users (including executives, lawyers, and auditors) an opportunity to quickly and easily find and retrieve e-mail messages, even those dating back many years.

E-mail archiving software applications offer the potential to reduce the e-mail load on network infrastructure and make messages readily available, but only at significant cost and complexity. For example, such systems typically have the following problems:
Expensive: Network based software applications that perform e-mail archiving represent a very significant investment for the organization. The cost to secure the license and the cost of annual maintenance are often prohibitively high for all but very large organizations. Licensing costs alone for such software could typically cost a small or midsize company well over $100,000. When the licensing cost is added to required infrastructure, the total investment becomes even more exorbitant;
Time Consuming to Deploy: Network-based software applications are often difficult and time consuming deployments. Even once a suitable window has been identified as allowable by the IT department to install such software, the installation and configuration is often much more complicated then was represented by the vendor. Because e-mail archiving software is a network application that must work with the organization's e-mail application, integration of the two applications is often required. Application integration can be a very time-consuming and arduous task, often prolonging the deployment by many months;.
Difficult to manage: A recent Radicati Group report on e-mail archiving software solutions reported that a majority of organizations who had a software solution deployed for less than one year, were not loyal to this solution. Their biggest complaint was that the software was time-consuming to manage; and
Tied to a specific vendor: Most e-mail archiving software applications are designed to work with a particular vendor's messaging application (e.g., Microsoft Exchange or IBM/Lotus Notes). This builds an even tighter dependency for the organization on that one vendor, restricting its ability to replace the application or make significant modifications to it. In addition, if the organization is using more than one e-mail application (a reasonably common occurrence), they would need to deploy two different e-mail archiving applications with two different archival repositories.

There is therefore a need for a method of and system for management of e-mail which addresses the problems outlined above.

### SUMMARY OF THE INVENTION

The present invention relates to a method of and system for management of electronic mail or e-mail.

The invention is based on the principle of intercepting messages before they arrive in the corporate e-mail system, using an e-mail gateway. E-mail is proactively pushed to an archive (network storage) as compared with a pull approach that pulls messages out of the mail-server. Using this push approach, the e-mail gateway sends or writes an e-mail message as a flat file to a designated network storage resource. The push model delivers an easy means to reduce the e-mail load on both servers and users, and with a proper replay system, can provide quick and easy access to archived e-mails.

The message replay system for archived e-mail described herein is primarily expected to be used with gateway approaches as described above, but is not restricted to these environments.

According to the present invention there is provided a method of managing electronic messages comprising the steps of: receiving incoming electronic messages; storing the incoming electronic messages on a centralized data storage device before or while the incoming electronic messages are being delivered to an existing electronic mail system; delivering the incoming electronic messages to the existing electronic mail system; and in response to a replay request from an End User, replaying selected ones of the stored electronic messages to the End User, by re-delivering the selected ones of the stored electronic messages, via the existing electronic mail system.

According to another embodiment of the invention there is provided a network appliance comprising: means for receiving incoming electronic messages; means for storing the incoming electronic messages on a centralized data storage device before or while the incoming electronic messages are being delivered to an existing electronic mail system; means for delivering the incoming electronic messages to the existing electronic mail system; and means of being responsive to a replay request from an End User, by replaying selected ones of the stored electronic messages to the End User, re-delivering the selected ones of the stored electronic messages, via the existing electronic mail system.

According to a further embodiment of the invention there is provided a system for managing messages comprising: a communication network; a network appliance; a data storage device; a message server; a User-interface device; the network appliance being connected to the communication network, the data storage device and the message server; the message server being connected to the User-interface device; the network appliance being operable to: receive incoming electronic messages; store the incoming electronic messages on a centralized data storage device before or while the incoming electronic messages are being delivered to an existing electronic mail system; deliver the incoming electronic messages to the existing electronic mail system; and in response to a replay request from an End User, replay selected ones of the stored electronic messages to the End User, by re-delivering the selected ones of the stored electronic messages, via the existing electronic mail system; and the message server being operable to route incoming electronic messages to the User-interface device.

The system and method of the invention will generally be implemented by retrieving e-mail from an archival storage, and “replaying” the messages through an existing corporate messaging system. It includes the ability to preview archived messages and redeliver one or more messages to a designated user's mailbox. The system also provides a means to reply to an archived message and to forward an archived message to another user (to their mailbox). Upon receiving, but before accepting, an incoming electronic message the message transport will preferably perform a three-way handshake with both the message server and the data storage device to verify the readiness of each to accept the message. This is so that the embodiment will not accept a message that the message server is not prepared to deliver or that the data storage device cannot archive.

The message replay system for archived e-mail (referred to within as the “Replay System”) first performs a search for e-mail messages stored in a network data storage system (referred to within as the “archive”) installed on a corporate network or accessible over the Internet. The system displays messages meeting user-specified criteria, provides an option to preview individual e-mail messages while still in the archive, and delivers selected message(s) to a designated mailbox with little or no dependency on the organization's installed e-mail application. The Replay System also archives messages and retains data on messages when the user is listed as a Blind Carbon Copy recipient.

The Replay System provides four main services related to retrieval of messages from the archive. With each of these services, the system submits a fully formatted and properly addressed message to the inbound queue of an e-mail server and the e-mail server subsequently delivers the message to the designated mailbox. The Replay System can use its own mail transport, in which case, outgoing mail does not first need to be transferred to a separate mail server. The four services provided by the Replay System are:

1. Redeliver Service

As the primary purpose of the Replay System, the Redeliver service provides the user with a means of retrieving one or more e-mail messages from the archive by re-delivering the message(s) to the users e-mail mailbox, a process that is independent of the e-mail software application in use.

2. Reply Service

The Reply service provides users with an ability to respond to the sender of a message or a collection of addressed recipients in the To:, CC:, or BCC fields (commonly called Reply to All) stored in the archive without the need to first have it re-delivered to an inbox, and without the need to use an e-mail application to author the message. Using Reply, a user selects a message in the archive, authors a response and then sends the message out for delivery, either directly or through an existing e-mail server application (such as Microsoft Exchange or Lotus Notes).

3. Forward Service

The Forward service offers similar functionality to the Reply service but with the provision for entering one or more e-mail addresses in the address fields (including To:, CC:, and BCC: fields) so that an archived message can be sent, along with an authored response, to any e-mail address without first being sent to a mail server application. This service also includes the ability to compose and send a new message.

4. Preview Service

The Preview application gives users the option of viewing a message while it is still in the archive for the purpose of uniquely identifying a specific message, before committing to redeliver it, or simply to read it. For added convenience, users are able to replay the message (including Redeliver, Reply, and Forward) directly from a Preview window.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 presents a system block diagram of basic capture functionality in an embodiment of the invention;

FIG. 2 presents a system block diagram of basic message replay functionality in an embodiment of the invention;

FIG. 3 presents a flow chart of the search process in the message replay system, in an embodiment of the invention;

FIG. 4 presents a flow chart of the list process in the message replay system, in an embodiment of the invention;

FIG. 5 presents a flow chart of the replay process in the message replay system, in an embodiment of the invention;

FIG. 6 presents a flow chart of the reply sub-process in the message replay system, in an embodiment of the invention;

FIG. 7 presents a flow chart of the forward sub-process in the message replay system, in an embodiment of the invention;

FIG. 8 presents a hardware block diagram of an exemplary embodiment of the invention; and

FIG. 9 presents a software architectural diagram of an exemplary embodiment of the invention.

### DETAILED DESCRIPTION

The following description is of a preferred embodiment. A number of terms are used in the description of this preferred embodiment which are defined as follows. It would be understood to one skilled in the art that the use of these terms would not restrict the application of the invention:

Archive: An “archive” or “archival storage” refers to a storage resource that is accessible to users or indirectly to users through the Replay System (which has direct access to the storage resource). In the context of e-mail content, an “archive” can also be implemented as a corporate message repository, sometimes called an “active archive”.

Archive Database: The Archive Database is a database that holds records containing index or metadata describing each e-mail messages in the archive. The assumption is that this data is gathered automatically as messages pass through the e-mail archiving process.

Carrier Message: The Carrier Message is a message generated by the Replay System when it replays an archived message. The archived message when replayed is either carried as an attachment to a Carrier Message or delivered as a distinct message.

Flat files: It is preferable that messages (and their attachments) be stored as vendor-neutral flat files and not as application objects that are only usable by certain applications. E-mail applications typically store e-mails in proprietary object formats which are not compatible with one another.

Message: A “message” or “e-mail message” refers collectively to all parts of the message including the headers, the message body and the attachments.

Message Map: A Message Map is data contained in the archive database record that specifies the exact location of each of the various parts of an archived message. Just as a geographic map describes the location of various geographical landmarks, the Message Map tells the archiving system where individual components of a message are located. This is important because despite the many standards that underlie e-mail formats and processes, the exact location of the header, body, and various attachments, varies from message to message. The Message Map is captured during the archiving process (while the file is being written to network storage).

Preview Content: Preview Content is the content displayed in the preview window in the Preview Service, and includes the message body and selective header information such as Sender, Recipient(s), Date, and Subject line.

Replay: “Replaying” or to “replay” refers to the act of re-delivering a message stored in the archive to a designated e-mail address that is either the original recipient (redeliver), the original sender (reply), or a new address (forward).

User: A “User” in this document refers to a typical user of the organizations messaging system (e.g., employee). Additional privileges may be accorded to others such as administrators or operators.

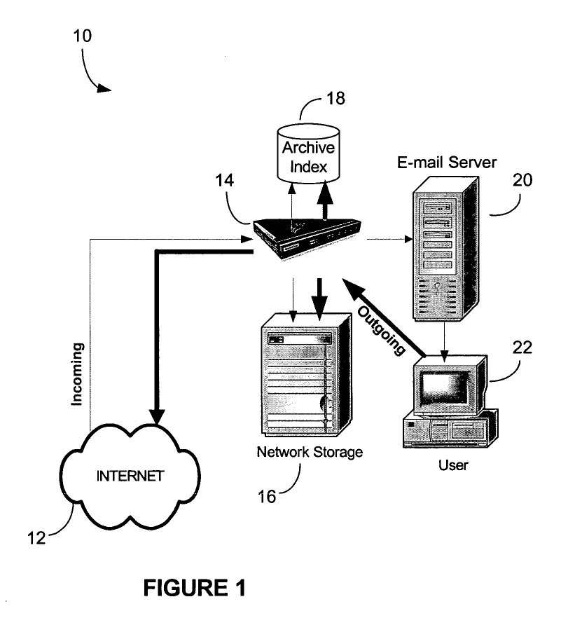

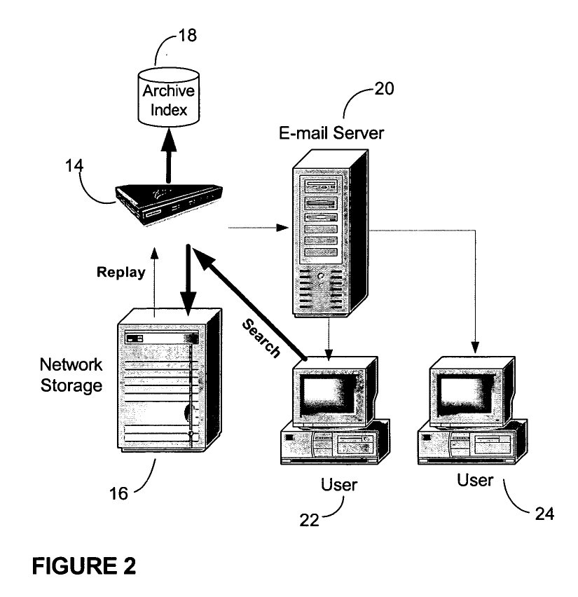

FIGS. 1 and 2 present system block diagrams of basic capture and replay functionality, respectively, in an embodiment of the invention.

In the system 10 of FIG. 1, e-mail messages arrive from the Internet 12, at the Network appliance 14 of the invention. As will be described hereinafter, the Network appliance 14 has the functionality to process a typical received e-mail message by storing it on the network storage device 16, indexing it in the archive index 18, and passing it to the e-mail server 20. Generally this will only be done after first verifying the readiness of both the network storage device and the e-mail server to receive the message, using a three-way handshake. The e-mail server 20 will then process the received e-mail message in the same manner as any typical e-mail message, passing it to the user computer 22. All of these communications are shown in FIG. 1 using thin lines.

This is a very simplistic description of the system is an effort to identify the most significant components related to the invention. Many applications of the invention will have a more complex arrangement, for example, the interconnection between the Network appliance 14 and the Internet 12 may include a digital cable modem, router, firewall or other components. Similarly, the communication between the e-mail server 20 and the user computer 22 will typically be via a local network or a Wide Area Network (WAN) of some sort, such as an Ethernet. It would be clear to one skilled in the art that the invention is independent of the nature of such components.

Outgoing e-mail messages follow a complementary path, passing from the user computer 22 to the Network appliance 14. The Network appliance 14 of the invention has the functionality to process this outgoing e-mail message by storing it on the network storage device 16, indexing it in the archive index 18, and passing it to the Internet 12. All of these communications are shown in FIG. 1 using thick lines. Alternatively, the outgoing message may first be routed through the mailserver and then to the appliance.

The searching, listing and replaying of stored e-mail messages does not require any re-arrangement of the system components. The searching, listing and replaying processes are described in greater detail hereinafter, but in short they can be described as follows:
Search Process: The self-service process engaged by the e-mail user to search for messages stored in the archive;
List Process: The automated process that displays a list of messages meeting user-defined search criteria and providing the user with the option of previewing messages; and
Replay Process: The automated process that retrieves specified message(s) from the archive and delivers the message(s) to a designated mail inbox, using the corporate e-mail system or an onboard e-mail transport service for delivering the message(s). The Replay Process also includes two sub-processes: the Reply Sub-process and the Forward Sub-process.

As shown in the system block diagram of FIG. 2, the replay of a message is initiated from the user computer 22, who sends a search request to the Network appliance 14. The Network appliance 14 has the functionality to search the archive index 18 for messages which comply with the user's search parameters, and return the search results to the user computer 22. The communications between search components in FIG. 2 are shown using thick lines.

The user then identifies the messages that are of interest to him, and what he would like to do with those messages. If the user simply wishes to view an archive e-mail message, will be displayed for him in a Preview window. If the user wishes to retrieve the message (to his personal inbox), it will be redelivered (replayed) to him. If the user wishes to forward an archived e-mail message to another computer 24, that is done either directly by the Network appliance 14 or via the local e-mail server 20, the archived e-mail message being delivered as a regular e-mail message.

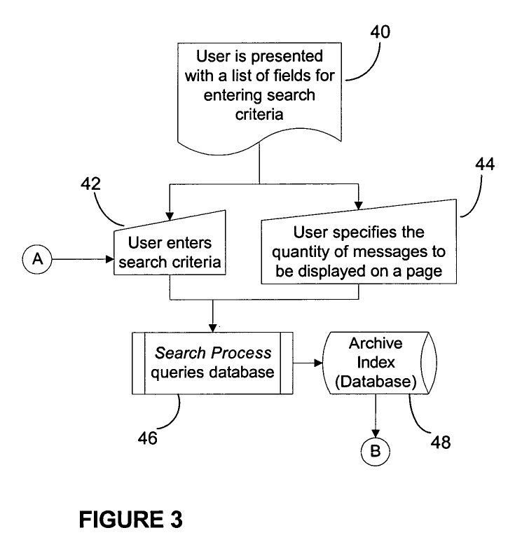

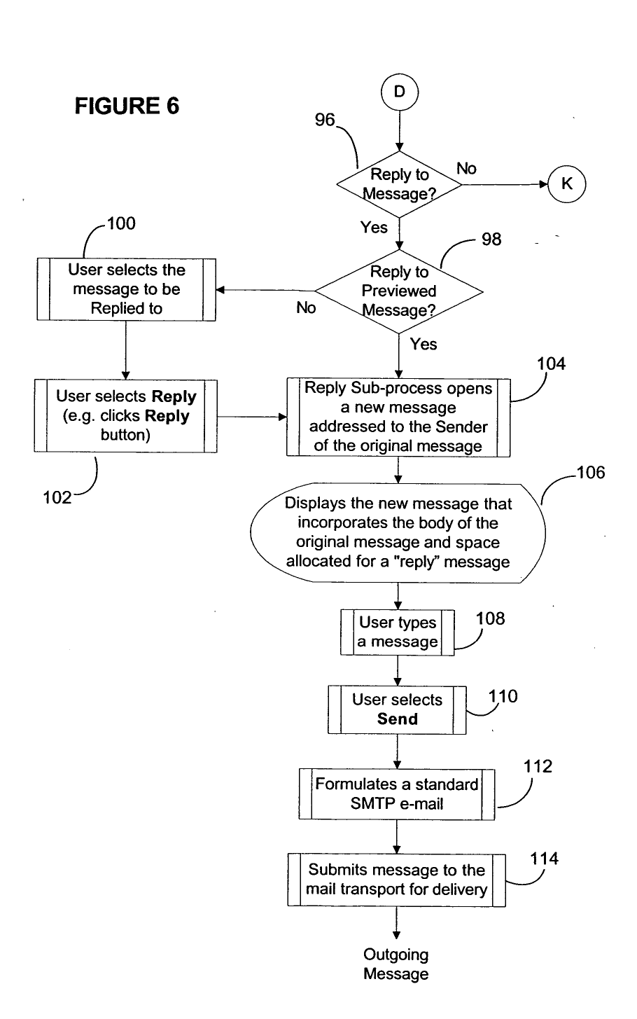

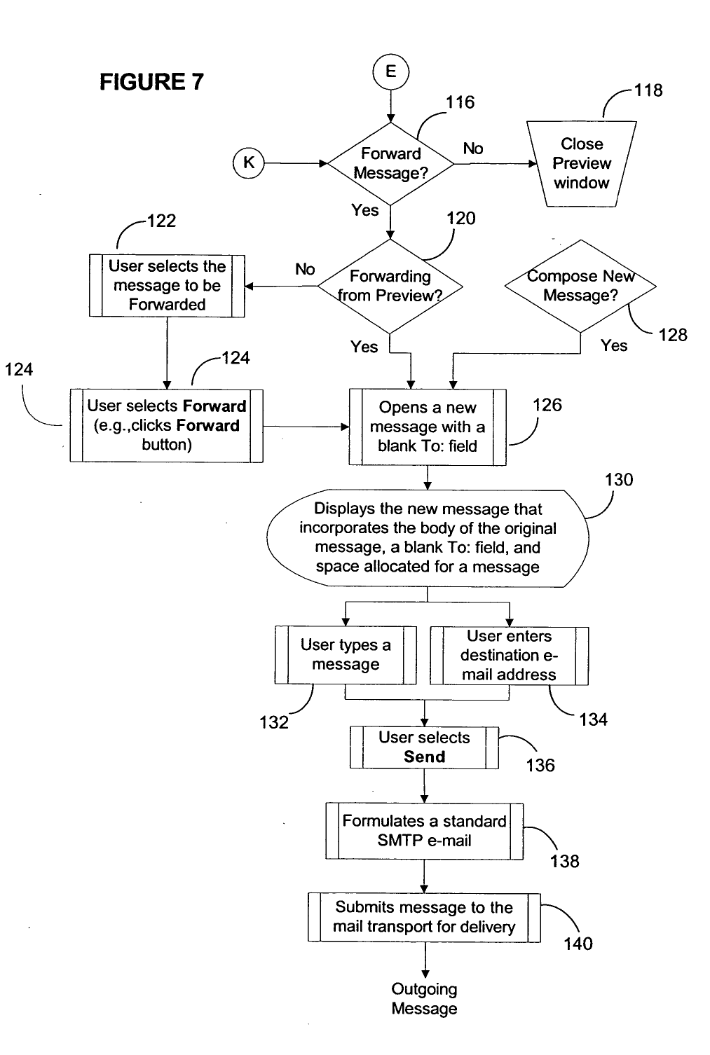

There are four component processes that constitute the Message Replay System for Archived E-mail and together provide the functionality previously described, namely the Redeliver, Reply, Forward, and Preview Services. These component processes are described in detail with respect to the flow charts of FIGS. 3 through 7. FIGS. 3, 4 and 5 illustrate the search, list (which includes Preview), and replay processes respectively. FIGS. 6 and 7 illustrate the process for replying to, and forwarding, messages in the archive.

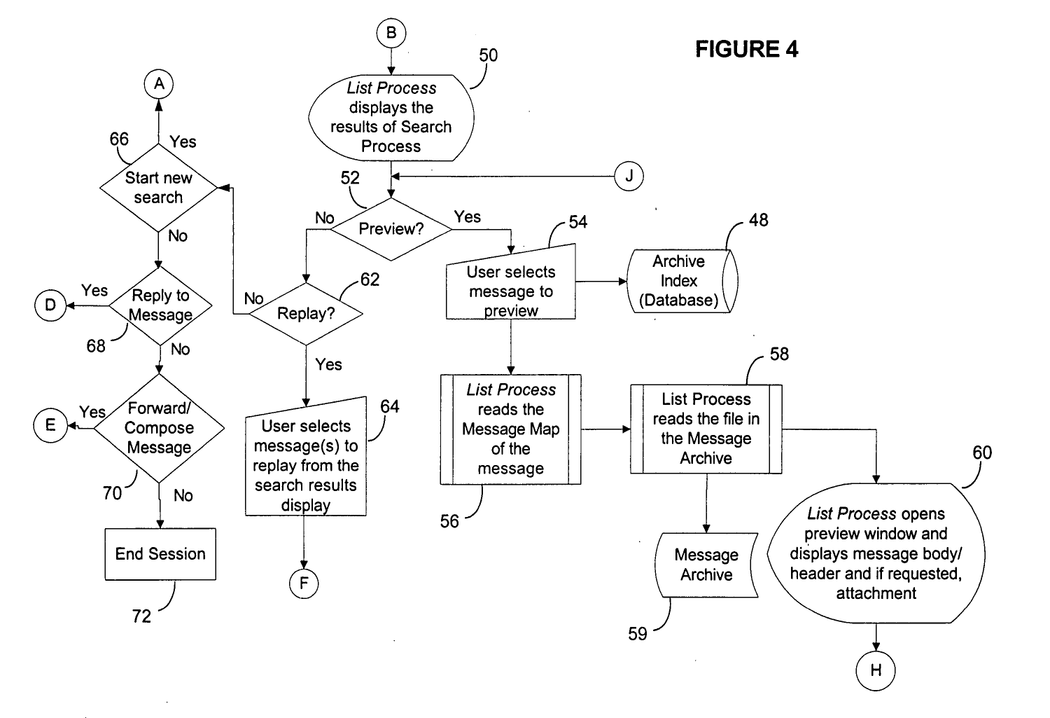

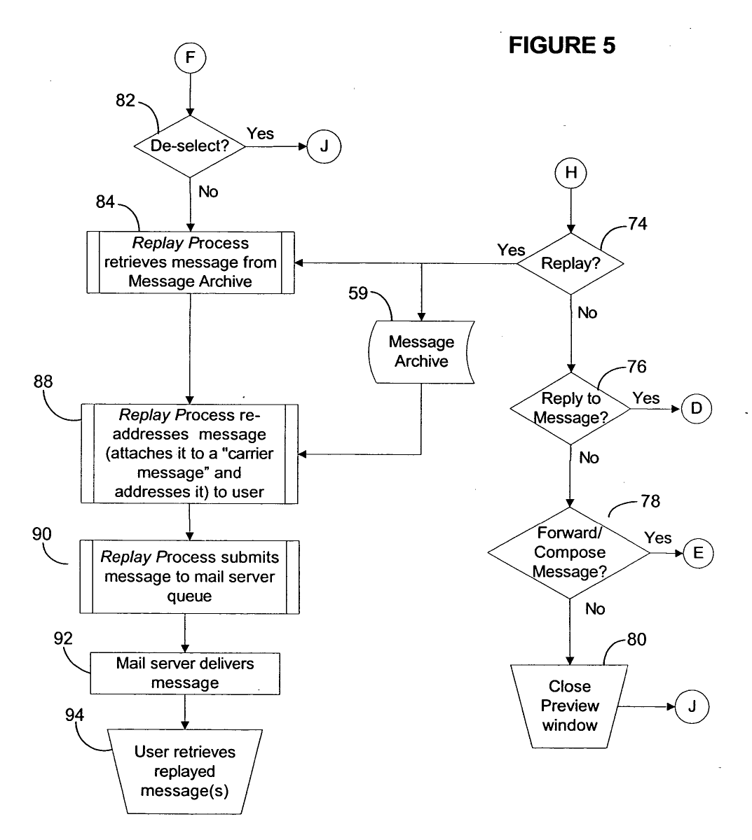

The Search Process of FIG. 3, is a self-service process engaged by the e-mail user to search for messages stored in the archive. The List Process of FIG. 4, is an automated process that displays a list of messages meeting user-defined search criteria and providing the user with the option of previewing messages. The Replay Process of FIG. 5, is an automated process that retrieves specified message(s) from the archive and delivers the message(s) to a designated mail inbox, using the corporate e-mail system or an onboard e-mail transport service for delivering the message(s).

The Replay Process of FIG. 6 is used to send a message directly from the archive to other recipients. The Forward Sub-process of FIG. 7 can be used for forwarding archived messages as well as composing and sending new messages. In the case of a new message, the user opens a blank message template to begin, rather than a previously archived message.

The flow charts of FIGS. 3-7 illustrate the sequence of events and processes that constitute the Message Replay System for Archived E-mail (Replay System). The user activates the Replay System by launching an application running on a designated network appliance or a network server.

At step 40, the user is presented with a list of fields for entering search criteria. A number of options are available for designating specific e-mail search criteria, including the types of fields that are commonly used in most search utilities in typical e-mail applications, such as user address in (in the To field), original sender (in the From field), and adding “Replay” to the Subject field. The system should offer the option of searching message body and/or attachments.

The user then specifies his/her search criteria in the fields provided by the application at step 42. These fields could, for example, be a combination of drop-down menus or text blocks into which the user types text strings for which the process will search. The system may also allow the use of wildcards and other such editing elements.

The user has the option of specifying the number of successful matches at step 44 (i.e., e-mail messages matching the specified criteria) from the search results that will be displayed on a single page. The user may choose to decrease this quantity if they prefer to look through fewer matches at a time, or increase the quantity when it is practical to display a large quantity at once—if, for example, a bulk retrieval is required.

The system's Search Process 46 queries the Archive Database 48 containing metadata captured from each e-mail message and describing its structure, contents (keywords) and exact physical stored location of the file. It is this Archive Database 48 that users query when searching for archived messages.

In the preferred embodiment of the invention, the Archive Database consist of an onboard (on the same device) or offboard (on a connected device or on a separate network server) relational database that retains a record of each message and contains fields containing metadata about each message (e.g., Sender, Recipient, Subject, etc). Each database record also contains the Message Map for that specific message as well as a pointer to the physical location of the file in storage so that it can be easily located. The primary purpose of the database is to provide the means for a user to search for archived e-mail messages. The Search process launches SQL queries against the database. The database is structured with multiple tables so that users will not experience searching performance degradation as the volume of archived messages grows. The process flow then passes to the List Process of FIG. 4, via path B.

The List Process receives the results of the Search query at step 50, and displays a list of the found messages. The user is presented with the option of previewing any one of the listed messages at step 52.

If the User chooses to preview a message at step 52, he/she must first select the specific message to be previewed at step 54. The system must then go to the record in the database in order to read the Message Map 48.

The List Process then identifies the specific record in the Archive Database relating to the message to be previewed, at step 56, and by reading the structural description contained in the Message Map 48 in the database record identifies where within the archived file the content to be displayed is located.

The List Process then locates the file and retrieves the Preview Content at step 58 by accessing the message archive 59. This will include the message-body along with header information necessary to be displayed (e.g., message body plus To:, From:, Subject:, Date, etc) from the file in the archive, ignoring all other data filed with the archived message.

The List Process opens a preview window at step 60 and displays the Preview Content from step 58, offering the user the option (e.g., buttons to click on, hot keys, etc) of replaying the message to the user's mailbox, replying by sending a responding e-mail to the sender of the original message, forwarding the message to another e-mail address, or closing the window. These options are accessed as shown in FIG. 5, via path H.

If the user decided at step 52 not to preview a message, then he/she also has the option of replaying a message per step 62. If the user wishes to replay a message directly, rather than through the preview window, then he/she identifies that message at step 64. From the list of messages displayed, the user selects one or more messages to be replayed. An option is offered to easily select all of the displayed messages for replay as well as the option of de-selecting messages that had been previously selected. The process flow then passes to FIG. 5 via path F.

If the user decides at step 62 not to replay a message, then he/she still has the options of starting a new search, replying to a message, or forwarding a message. These options could be presented to the user in various ways, but are presented successively in FIG. 4, in the interest of simplicity. If the user wishes to perform a new search at step 66, then the process flow returns to step 42 of FIG. 3, via path A. If the user wishes to reply to a message at step 68, process flow passes to FIG. 6 via path D, and if the user wishes to forward a message at step 70, process flow passes to FIG. 7 via path E. If the user does not wish to pursue any of these, then the routine ends at step 72.

A flow diagram of the replay process is presented in FIG. 5.

Similar to steps 62, 66, 68 and 70 above, the user is presented with various selections via path H, specifically selection steps 74, 76, 78 and 80. At step 74, the user is given a “replay” option. If the user wishes to replay an e-mail, then control passes to step 84, but otherwise, control passes to step 76. If the user wishes to perform a reply to a message at step 76, process flow passes to FIG. 6 via path D, while if the user wishes to forward a message at step 78, process flow passes to FIG. 7 via path E. If the user does not wish to pursue any of these, then the preview window closes at step 80 and process flow returns to FIG. 4 via path J.

If the user did enter the replay selection at step 74, then process flow passes to step 84, where the data contained in the Archive Database record is used, in particular, the exact physical location where the file is stored, to locate the file (e-mail message) stored in the archive and to retrieve it.

At step 88, the Replay Process then prepares the archived message for re-delivery back to the user, either addressing it to the user, or delivering it as an attachment to a Carrier Message (a separate e-mail message that acts as an envelope around the archived message) which is itself addressed to the user.

At step 90, the Replay Process then submits the message to the inbound queue of the mail server application, and the mail server application delivers the e-mail message to the specified mailbox at step 92 as it does with any other e-mail message. This step can be bypassed when utilizing the appliance's own mail transport.

Once the message has been delivered by the e-mail application to the user's mailbox, the user retrieves and opens the message at step 94. If the archived message is sent as an attachment, the attachment must be opened to open the archived message. Otherwise, the message that is replayed to the user's Inbox is itself the archived message (retrieved from the archive without a carrier message).

Note that the User has the ability to enter this process via path F from FIG. 4. If the User decides at step 82 that he does not wish to process the messages he selected at step 64 of FIG. 4, then processing returns to FIG. 4 via path J.

FIGS. 6 and 7 are flow diagrams illustrating the sequence of events and processes of the Reply sub-process and the Forward sub-process respectively. These are sub-processes to the Replay Process of the Message Replay System for Archived E-mail. In other words, these sub-processes utilize the Replay Process to provide Reply and Forward (including Compose) functionality.

The Reply Sub-process of FIG. 6 provides the ability to respond to an archived message without the requirement to first retrieve the message using an e-mail application. The Forward Sub-process of FIG. 7 provides the ability to forward an archived message to another e-mail address without the requirement to first redeliver the message to an e-mail application inbox (e.g., Microsoft Outlook).

The Reply Sub-process of FIG. 6 begins at step 96 where the user is queried as to whether he wishes to reply to a message. A negative response causes the process flow to travel to FIG. 7 via path K. A positive response causes the process flow to travel to step 98 where the user is queried as to whether he wishes to reply to a previewed message.

A negative response causes the process flow to travel to step 100, where the user chooses a message listed in the Search Results display as the message for which a reply is intended, for example, by checking a corresponding box. At step 102, the user then selects the Reply feature either by selecting the feature from a list of other features when right-mouse clicking or by selecting a button labeled Reply.

The Reply Sub-process then opens a new message at step 104 and copies the address from the From: field of the original message to the To: field of the new message. Note that the user can also select the Reply feature directly from within a preview window as shown in the link between steps 98 and 104. The Reply to All option copies all of the recipients of the original message to the To: field of the new (reply) message.

At step 106 the user is presented with a message body that includes the original archived message (the message being replied to) with the To: field addressed to the original sender (a list of recipients in the case of Reply to All), and a blank area that is available for the user to enter a message.

Using the blank area in the message the user then enters a message for the intended recipient (the sender(s) of the archived message), at step 108. The user then selects Send at step 110 and the Reply Sub-process formulates a standard SMTP message (IETF RFC 822) using the data provided, at step 112. The Reply sub-process submits the RFC 822 message to a mail transport at step 114, either on the same server or appliance, or a different server/appliance, resulting in an outgoing e-mail message.

The Forward Sub-process of FIG. 7 begins at step 116, where the user is queried as to whether he wishes to forward a message. A negative response causes the preview window to be closed at step 118, while a positive response cause the user to be queried as to whether he wishes to forward a message from the preview window at step 120.

When the user chooses to Forward one of the messages listed in the Search Results display, he/she first selects the message intended to be forwarded at step 122. The user then selects the Forward feature at step 124 either by selecting the feature from a list of other features when right-mouse clicking or by selecting a button labeled Forward.

The Forward Sub-process then opens a new message at step 126 which includes a blank To: field. The user can also select the Forward feature directly from within a preview window. Optionally, to compose a new message, the user can open a blank message template at step 128. Note that the user may also open a new message by responding negatively to the query at step 120.

The user is then presented with a message body at step 130 that includes the original archived message (the one being replied to), a blank To: field, and a blank area that is available for the user to type a message.

The user is then able to enter a message using the blank area, to the intended recipient at step 132, and to enter the e-mail address of the intended recipient or recipients at step 134.

Much like steps 110-114 above, the user then selects Send at step 136 and the Reply Sub-process formulates a standard SMTP message (IETF RFC 822) using the data provided, at step 138. The Reply sub-process submits the RFC 822 message to a mail transport at step 140, either on the same server or appliance, or a different server/appliance, resulting in an outgoing e-mail message.

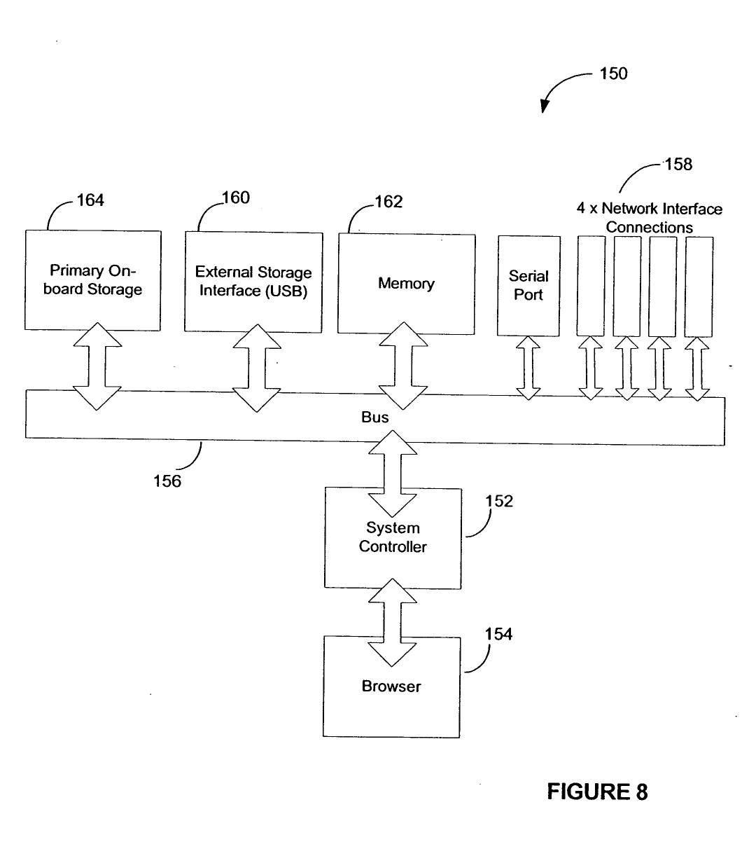

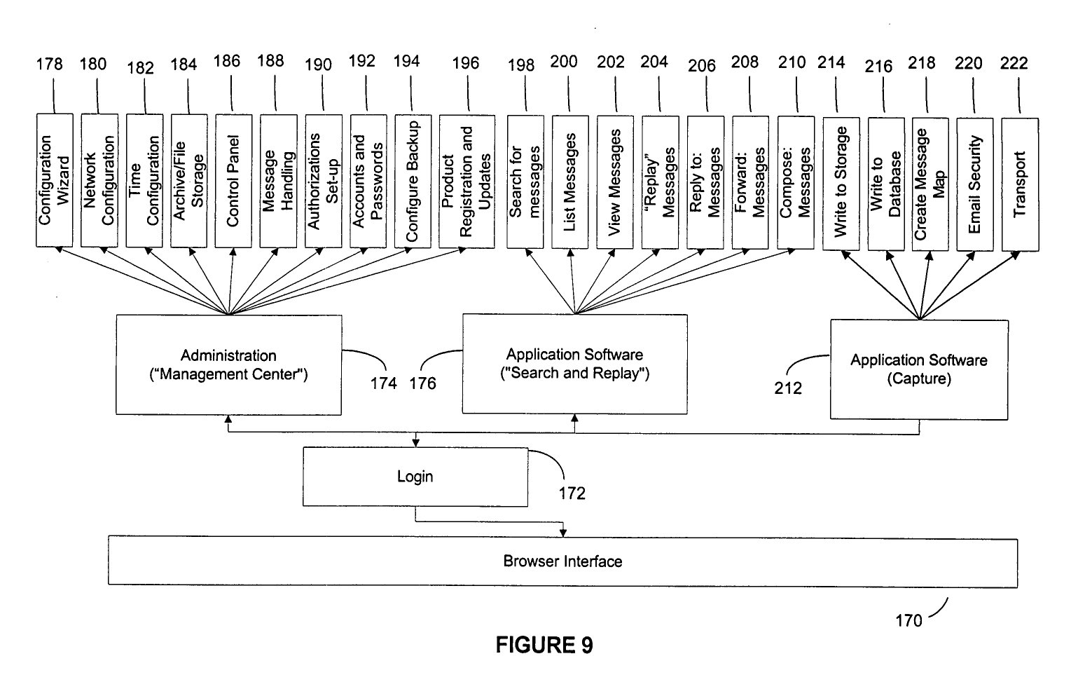

FIGS. 8 and 9 present a hardware block diagram and a software block diagram, respectively, of the network appliance embodiment 150 of the invention.

A network appliance functions primarily if not exclusively to serve a single application—in this case, archival of electronic mail messages including the corresponding retrieval of messages from archival repository (“e-mail storage”). The term “appliance” designates a device that offers a specific set of functionality, both hardware and software, that has been pre-installed and optimized for processing efficiency and does not require the user to purchase or install its constituent components. The qualifying term “network” in this context refers to the fact that the functionality of the appliance is accessed over the network and that the appliance is physically attached to the network using standard Ethernet network cables plugged into the RJ-45 Ethernet ports available on the appliance.

The preferred embodiment of the invention is built around a controller 152, which may be a microprocessor, RISC processor (reduced instructions set computer), ASIC (application specific integrated circuit), or similar device. The controller 152 interfaces directly with the on-board application which, in this embodiment, is running on an internal Compact Flash card. This could also run from a disk on a server 154, and with other components via bus 156. The use of the Web browser 154 allows the user to interface with the net appliance 150 using simple HTML pages and a Web browser on their personal computer 22.

The preferred embodiment of the device provides at least four (4) RJ-45 interfaces 158 so that it accords the optimum configuration flexibility and efficient utilization of network resources. For example, a designated Ethernet port (RJ-45) on the appliance 150 should be assigned for the public side of the network (exposed to the Internet) with a separate Ethernet port assigned for connecting to the private side (exposed to the customer's private network). The third and fourth Ethernet ports can be utilized to connect the appliance directly and securely to the network storage system and to a designated management interface, respectively.

The Ethernet interfaces 158 are preferably compliant with the IEEE 802.3 standard. Each interface supports 10 MB per second, 100 MB per second or 1000 MB per second transfer rates and N-Way auto negotiation. Each interface also supports full duplex communication and is compliant with PCS Revision 2.1 and PCI Bus Master data transfers.

The network appliance 150 also includes two standard USB connectors 160 which allow for the direct attachment to the appliance of additional storage in the form of attachable hard drives. This additional storage increases the capacity of the appliance's on-board Archive Index (database). The second USB connector provides either additional back-up storage should one fail, or when both are utilized concurrently, it doubles the available storage.

A serial interface is also available (not shown in FIG. 8) should the system administrator be required to telnet into the device for specific maintenance functions.

Internally, the network appliance 150 also contains System Memory 162, BIOS, On-Board Storage 164, Input/Output (I/O) interfaces, and status LEDs (light emitting diodes) to the following specifications:

| | |
|---|---|
| CPU | Low power VIA Eden/C3 processor, 400 MHz |
| | VIA VT8601T + VT82C686B chipsets |
| System Memory | 128 MB SDRAM onboard (1 × 168-pin DIMM |
| | sockets, PC133 SDRAM) |
| BIOS | Phoenix-Award BIOS with 2 M-bit Flash EPROM |
| Onboard Storage | CompactFlash ™ Type II Socket with 2 Gbyte memory |
| | card |
| I/O Devices | Two (2) USB ports (USB 1.1a compliant) |
| | Two (2) ATA-100 IDE(1 × 40-pin and 1 × 44-pin) |
| | Four (4) Realtek RTL8139C Ethernet interfaces |
| VGA Controller | AGP interface controller integrated in VIA VT860IT. |
| | Supports CRT display only. |
| USB Connectors | Standard 8-pin double stack (2) USB connector |
| LEDs | One LED for Power, one LED for Status, and four |
| | LEDs each for Link and Active for each LAN |
| | connection |

The appliance includes no moving parts to decrease the likelihood of failures. That is, no fans or the like.

Other specifications of the preferred embodiment include the following:

| | |
|---|---|
| Size | 150.6 mm × 210 mm × 30 mm |
| Weight | 1.37 kg |
| Battery | Lithium 3V/196 mAH |
| Temperature | 0-60° C. operation |
| Operating Humidity | 10%-95% relative humidity, non-condensing |
| Power | 2-pin 5 Volt DC (4 Amp maximum). Power |
| | Management: ACPI. Power supply included |

A block diagram of the software architecture of the network appliance 150 is presented in FIG. 9. The software is built using the following third-party software:

| | |
|---|---|
| Free BSD Rel 5.3 Rel −p5 | Operating system |
| Apache Rel 2.0.53 | Web-application on which the Search and |
| | Replay application runs |
| qMail Rel 1.05 | Message transfer agent that relays, generates, |
| | and receives e-mail messages |
| PostGres Rel 8.0.1 | Database application that manages the |
| | Archive Index |
| | (database of archived mail messages) |
| PHP Rel 5.0.3 | Programming language |

As shown in FIG. 9, the software is accessed via a browser interface 170 and a login/password module to authenticate users 172. The actual software modules are divided into three groups: the administrative modules (or “Management Center”) 174, the capture modules, and the application software (or “Search and Replay”) 176.

The administrative module 174 is built out of the following sub-modules:
the configuration wizard 178, which is a series of sequenced pages offering step-by-step instructions for the system administrator for the installation of the embodiment. The wizard is self-paced and results in a fast and confident installation experience;
the network configuration module 180, which assists the system administrator set up the network interfaces, host names, domain names, DNS server, as well as interfaces to the e-mail server;
the time configuration module 182, which assists the system administrator define its time zones, set the system time, or designate an NTP Server for setting the time;
the archive/file storage module 184, which assists the system administrator define the locations of the Archive and the Archive Index (Database) as well as specifying the notifications of archive capacity threshold warnings and deleting and/or backing up messages in the archive;
the control panel module 186, which provides services for the system administrator to start and stop the message transport and/or the Archive Index, manually activating a synchronization of the database, re-initializing, as well as shutting down or starting up, the appliance;
the message handling module 188, which assists the system administrator set up the Postmaster, Address Verification, Sender Verification, Registered Blacklist Look up, Spammer Tar-pit and other security features;
the authorization set-up module 190, which assists the system administrator select its preferred profile for creating accounts and assigning passwords, specifically whether accounts are opened by the system administrator or by users themselves, and whether or not passwords will be system generated and automatically distributed;
the accounts and passwords module 192, which assists the system administrator open, close and list accounts;
the configure backup module 194, which helps the system administrator back up the configure file on the network and when needed, to restore it; and
the product registration and updates module 196, which assists the system administrator register the product or change registration parameters (e.g., number of mailboxes supported) with the vendor or service provider, and install software updates.

The Search and Replay application software 176 is built from the following sub-modules:
the search for messages module 198, which includes a user interface that provides users with the ability to define search criteria and then activate the search. The search for messages module then queries the Archive Index looking for records (messages) that meet the specified criteria;
the list messages module 200, which displays a list of message headers for files (messages) that meet the specified criteria. In addition to the header information, the list page also displays a checkbox for selecting specific messages and a preview icon to be selected if the user wishes to view the archived message;
the view messages module 202, which when selected, opens a new window and displays within that window a view of the specified message header and body while it still resides in the archive. The window opened by the view messages module also includes the option of replaying the message directly from within that window;
the replay messages module 204, which when selected, will retrieve the file (message) from the archive, formulate it as a standard Internet e-mail message, re-address it to the user and either deliver it to the intray (message queue) of an e-mail-server on the network or deliver the message itself. The replay messages module will provide the option of replaying a message as an attachment or as an encapsulated message itself. System Administrators are provided with the right to replay a message to any e-mail account whereas a User is only permitted to replay a message to itself;
the reply to messages module 206, which when selected, provides the user with the ability to append a note to an archived message and send it back (with the attached note) to the original sender of the archived message, without first having to replay the message to the users inbox. The reply to messages module automatically places the senders e-mail address in the TO: field of the reply message;
the forward messages module 208, which when selected, provides the user with the ability to append a note to an archived message, address it to one or more e-mail addresses, and send the messages (and note), without first having to replay the message to the users inbox; and
the compose messages module 210, which when selected, provides the user with the ability to create a new message, address it, and send it, without the need for using an e-mail client software.

The software architecture of the Capture functionality is much the same, having software modules directed to particular functionality as described hereinabove. The Capture application software 212 is built from the following sub-modules:
the write message to storage module 214, which is a process that captures the e-mail message data stream and writes it as file to a storage resource on the network using a file sharing protocol like NFS (Network File System), CIFS (Common Internet File System), or other SMB (Server Message Block) protocols;
the write to database module 216, which records metadata (data that describes the message) in a database for subsequent search and retrieval from the archive;
the message-map module 218, which records the exact physical locations of each of the component parts of an e-mail message so that individual components can be acted on e.g., viewed; and
the e-mail security module 220, which applies a series of verifications to determine if an incoming message should be accepted. The e-mail security actions include verifying that the addressed recipients are valid registered users; verifying that the address of the designated sender of the message is a valid mailbox; verifying that the sending domain (message server) is not on a designated list of known spammers; and warding off senders of spam messages (unsolicited mass mailings) by delaying acceptance of messages from new domains, a function called greylisting; and
the transport module 222, which sends e-mail messages to the message server or directly to the Internet.

As noted above, other prior approaches to the problems of the invention were expensive, time consuming to deploy, difficult to manage, and tied to specific vendors. For example, network based software applications that perform e-mail archiving can charge well over $100,000 to secure the license and the cost of annual maintenance. The embodiment of the invention on the other hand is an appliance solution that, as with other appliance-based solutions, tends to cost a fraction of the cost of network software alternatives. The expected cost an organization will incur when deploying this embodiment will average between $3-12 per mailbox. The cost (in 2005) for network software applications currently range from $40-100 per user.

Network-based software applications are often difficult and time consuming deployments. Even once a suitable window has been identified by the IT department to install such software, the installation and configuration is often much more complicated then was represented by the vendor. An appliance-based solution on the other hand, like the embodiment of the invention, is designed to be operational and functioning (archiving mail) within a few minutes. The invention can easily take into consideration all aspects of the installation process and as such walk the administrator through the entire installation process in one sitting so that at its end, the system is fully operational.

As noted above, a recent Radicati Group report on e-mail archiving software solutions indicated that a majority of organizations who had a software solution deployed for less than one year, were not loyal to this solution and their biggest complaint was that the software was time-consuming to manage. An appliance-based solution like that of the invention is designed specifically to be self-managed and requires technical support only in extreme cases or when a new software version needs to be installed.

Last, most e-mail archiving software applications are designed to work with a particular vendor's messaging application (e.g., Microsoft Exchange or IBM/Lotus Notes). This builds an even tighter dependency for the organization on that one vendor, restricting its ability to replace the application or make significant modifications to it. The embodiment of the invention on the other hand, is application-neutral and creates one repository for all of the organization's e-mail, regardless of which server or client software application is being used. Furthermore, because it is vendor-neutral the organization is free to change its messaging system and the e-mail archiving and retrieval process continues unchanged for both users and administrators.

Other advantages of the invention would be clear to one skilled in the art from the description herein.

### Options and Alternatives

While particular embodiments of the present invention have been shown and described, it is clear that changes and modifications may be made to such embodiments without departing from the true scope and spirit of the invention. For example, the invention may easily be applied to instant messaging technology (IM), Internet surveillance, Voice over IP (VOIP), database archives and automatic taxonomy building and natural language indexing/searching.

Other options and alternatives include the following: Load balancing; Redundancy; Gateway to Gateway message encryption; User to User message encryption; Real-time connection to external Spam prevention services; Archiving messages to a commercial relational database products from Oracle, IBM, Microsoft, etc; Wireless messaging; Utilizing commercially available search tools; System problem notification and resolution using e-mail.

### CONCLUSIONS

The present invention has been described with regard to one or more embodiments. However, it will be apparent to persons skilled in the art that a number of variations and modifications can be made without departing from the scope of the invention as defined in the claims.

For example, the network appliance of the invention may be implemented using various combinations of electronic hardware, software and/or firmware.

The electronic circuits of the invention may be described by computer software code in a simulation language, or hardware development language used to fabricate integrated circuits. This computer software code may be stored in a variety of formats on various electronic memory media including optical and magnetic computer disks, CD-ROM, Random Access Memory (RAM) and Read Only Memory (ROM). As well, electronic signals representing such computer software code may also be transmitted via a communication network.

All citations are hereby incorporated by reference.

What is claimed is:

1. A method of managing electronic messages comprising the steps of:
receiving incoming electronic messages;
storing said incoming electronic messages on a centralized data storage device before or while said incoming electronic messages are being delivered to an existing electronic mail system;
delivering said incoming electronic messages to said existing electronic mail system; and
in response to a replay request from an End User, replaying selected ones of said stored electronic messages to said End User, by re-delivering said selected ones of said stored electronic messages, via said existing electronic mail system.

2. The method of claim 1, wherein all of said steps are performed by a network appliance.

3. The method of claim 1, wherein all of said incoming electronic messages are stored on said centralized data storage device.

4. The method of claim 1, wherein said incoming electronic messages are stored as native flat files.

5. The method of claim 1, wherein said step of storing further comprises the step of storing a message map associated with each said electronic message, said message map including data specifying the location of various parts of each said electronic message.

6. The method of claim 1, further comprising the step of responding to a preview request from said End User, by accessing a selected one of said stored electronic messages and presenting a preview of said selected one of said stored electronic messages without using said existing mail system.

8. The method of claim 1, wherein said step of re-delivering a selected one of said stored electronic messages to said End User, comprises the step of re-delivering a fully formatted and properly addressed message to the inbound queue of said electronic mail system and said electronic mail system subsequently delivering said message to a designated mailbox.

9. The method of claim 1, further comprising the step of responding to a reply request from said End User, by generating a reply to a given stored electronic message, without first delivering said given stored electronic message to said End User via said existing electronic mail system.

10. The method of claim 1, further comprising the step of responding to a search request from said End User, by searching through electronic messages stored on said centralized data storage device.

11. The method of claim 1, further comprising the step of responding to a forwarding request from said End User, by accessing a selected one of said stored electronic messages, preparing a new header identifying a destination address and forwarding said addressed message to said destination address.

12. The method of claim 1, wherein said step of searching comprises the step of searching for electronic messages agreeing with criteria specified by said End User, on said centralized data storage device.

13. A network appliance comprising:
means for receiving incoming electronic messages;
means for storing said incoming electronic messages on a centralized data storage device before or while said incoming electronic messages are being delivered to an existing electronic mail system;
means for delivering said incoming electronic messages to said existing electronic mail system; and
means responsive to a replay request from an End User, by replaying selected ones of said stored electronic messages to said End User, re-delivering said selected ones of said stored electronic messages, via said existing electronic mail system.

14. The network appliance of claim 13, further comprising means for previewing said stored electronic messages on said User-interface.

15. The network appliance of claim 13, further comprising means for replying to a sender of one of said stored electronic messages, without requiring the use of an e-mail server application at said User-interface.

16. The network appliance of claim 13, further comprising means for forwarding one of said stored electronic messages to a specified mailbox.

17. The network appliance of claim 13, further comprising:
means for searching said stored electronic messages for stored messages matching user-defined search criteria; and
means for displaying a listing of said stored messages matching said user-defined search criteria.

18. The network appliance of claim 13, further comprising means for re-delivering selected ones of said stored electronic messages.

19. The network appliance of claim 13, wherein said means for storing said incoming electronic messages on a data storage device comprises means for storing the header data, time stamp and date stamp and optionally, full text index of said incoming electronic messages, on said data storage device.

20. A system for managing messages comprising:
a communication network;
a network appliance;
a data storage device;
a message server;
a User-interface device;
said network appliance being connected to said communication network, said data storage device and said message server;
said message server being connected to said User-interface device;
said network appliance being operable to:
receive incoming electronic messages;
store said incoming electronic messages on a centralized data storage device before or while said incoming electronic messages are being delivered to an existing electronic mail system;
deliver said incoming electronic messages to said existing electronic mail system; and
in response to a replay request from an End User, replay selected ones of said stored electronic messages to said End User, by re-delivering said selected ones of said stored electronic messages, via said existing electronic mail system; and
said message server being operable to route incoming electronic messages to said User-interface device.

21. The system of claim 20, wherein said User-interface device is a personal computer.

22. The system of claim 20, wherein said communication network is one selected from the group consisting of a local area network, a wide area network, an Intranet, and an Internet.
